(19) United States
(12) Patent Application Publication
(10) Pub. No.: US 2025/0168960 A1
(43) Pub. Date: May 22, 2025

(54) METHOD FOR PRODUCING PLASMA PROCESSED LIQUID AND PLASMA IRRADIATION APPARATUS

(71) Applicant: FUJI CORPORATION, Chiryu (JP)

(72) Inventors: Toshiyuki IKEDO, Nagoya-shi (JP); Wataru KUSAKA, Okazaki-shi (JP)

(73) Assignee: FUJI CORPORATION, Chiryu (JP)

(21) Appl. No.: 18/832,252

(22) PCT Filed: Feb. 22, 2022
(86) PCT No.: PCT/JP2022/007224

§ 371 Date: Jul. 23, 2024

(51) Int. Cl. H05H 1/24; C02F 1/46

(52) U.S. Cl. CPC H05H 1/247; C02F 1/4608; C02F 2201/4612; H05H 2245/20

(57) ABSTRACT

A method for producing a plasma processed liquid, including: a supply step of supplying a liquid to be processed to a container; a discharge step of discharging the liquid to be processed from the container while supplying the liquid to be processed to the container in the supply step; and an irradiation step of irradiating the liquid to be processed supplied to the container with plasma, in which the plasma processed liquid is produced by irradiation of plasma in the irradiation step.

### TECHNICAL FIELD

The present disclosure relates to a technique for producing a plasma processed liquid by irradiating a liquid to be processed with plasma.

### BACKGROUND ART

Patent Literature 1 describes a technique for irradiating a liquid to be processed supplied to a container with plasma. Patent Literatures 2 and 3 describe a technique for supplying a liquid by a supply device such as a pump.

### PATENT LITERATURE

Patent Literature 1: WO2020/026324

Patent Literature 2: JP-A-H10-015573

Patent Literature 3: JP-T-2010-523326

### BRIEF SUMMARY

### Technical Problem

An object of the present description is to appropriately produce a plasma processed liquid by irradiating a liquid to be processed supplied by a supply device to a container with plasma.

### Solution to Problem

In order to achieve the above object, the present description discloses a method for producing a plasma processed liquid, including: a supply step of supplying a liquid to be processed to a container; a discharge step of discharging the liquid to be processed from the container while supplying the liquid to be processed to the container in the supply step; and an irradiation step of irradiating the liquid to be processed supplied to the container with plasma, in which the plasma processed liquid is produced by irradiation of plasma in the irradiation step.

### Advantageous Effects

In the present disclosure, while supplying the liquid to be processed to the container, the liquid to be processed is discharged from the container, and the liquid to be processed supplied to the container is irradiated with plasma. Accordingly, it is possible to properly produce the plasma processed liquid.

### BRIEF DESCRIPTION OF DRAWINGS

FIG. 1 is a perspective view of an atmospheric pressure plasma irradiation apparatus.

FIG. 2 is an exploded view of a plasma generating device.

FIG. 3 is an exploded view of the plasma generating device.

FIG. 4 is a cross-sectional view of the plasma generating device.

FIG. 5 is a perspective view of the atmospheric pressure plasma irradiation apparatus.

FIG. 6 is a side view of the atmospheric pressure plasma irradiation apparatus.

FIG. 7 is a side view of the atmospheric pressure plasma irradiation apparatus.

FIG. 8 is a perspective view of the atmospheric pressure plasma irradiation apparatus.

FIG. 9A is a perspective view of an irradiation block, and FIG. 9B is a cross-sectional perspective view of the irradiation block taken along line A-A.

FIG. 10 is a block diagram of a control device.

### DESCRIPTION OF EMBODIMENTS

An embodiment of the present disclosure will be described in detail below based on the accompanying drawings.

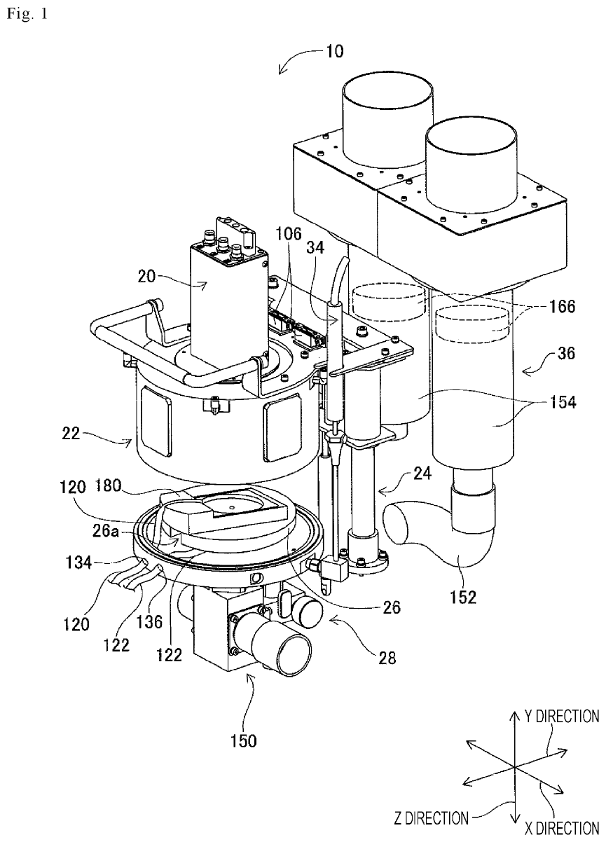

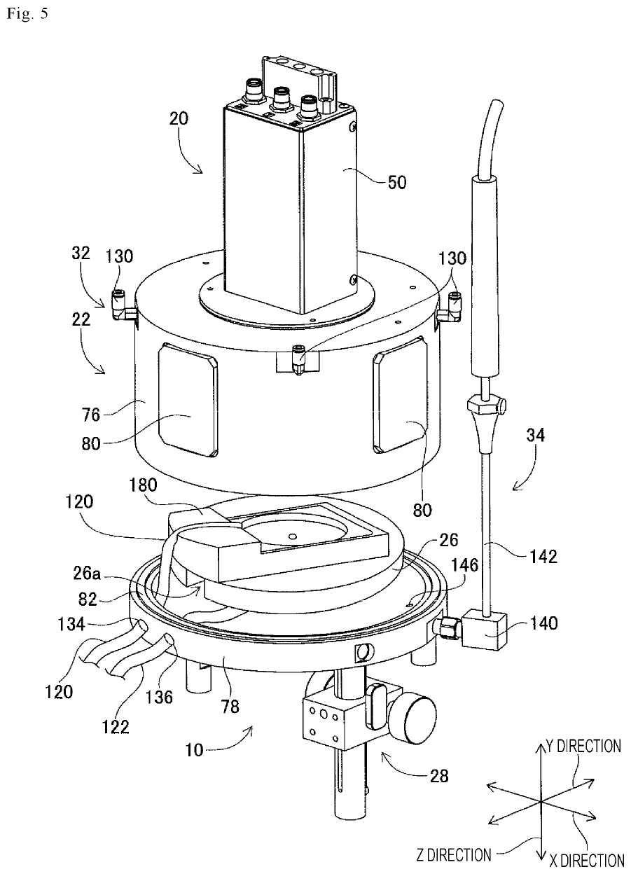

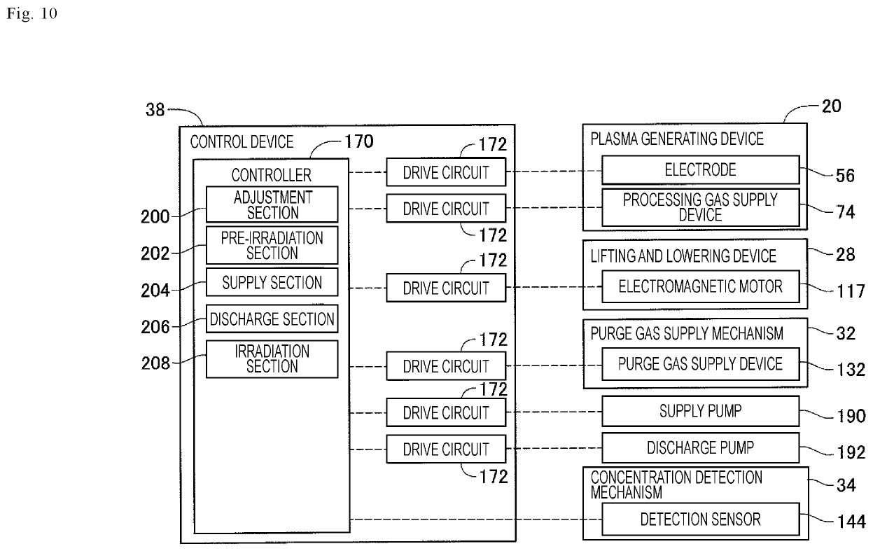

FIG. 1 shows atmospheric pressure plasma irradiation apparatus 10 according to an embodiment of the present disclosure. Atmospheric pressure plasma irradiation apparatus 10 is a device for irradiating a culture solution (an example of a “liquid to be processed”) with plasma under atmospheric pressure, and includes plasma generating device 20, cover housing 22, opening and closing mechanism 24, stage 26, lifting and lowering device 28, purge gas supply mechanism 32 (see FIG. 5), concentration detection mechanism 34, exhaust mechanism 36, and control device 38 (see FIG. 10). A width direction of atmospheric pressure plasma irradiation apparatus 10 is referred to as an X direction, a depth direction of atmospheric pressure plasma irradiation apparatus 10 is referred to as a Y direction, and a direction orthogonal to the X direction and the Y direction, that is, an up-down direction is referred to as a Z direction.

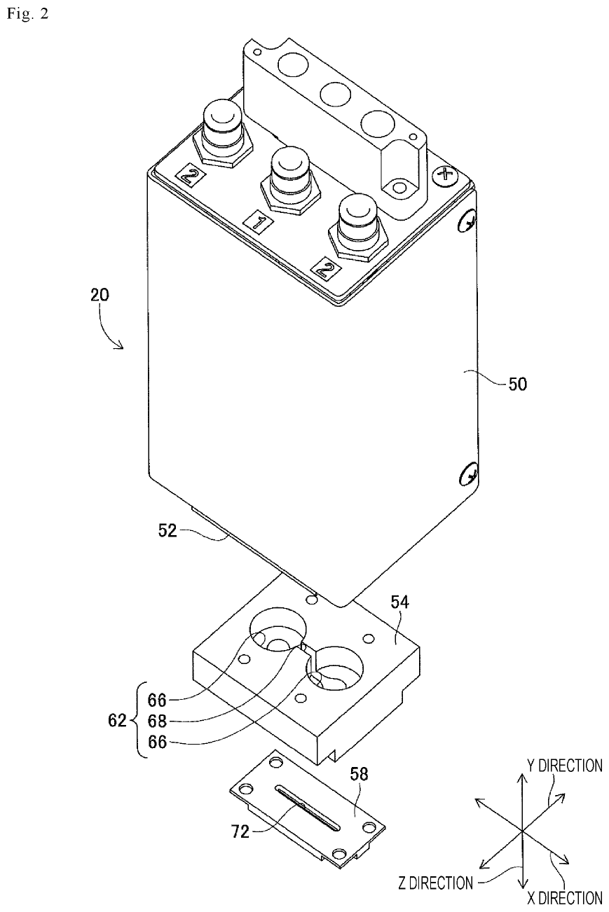

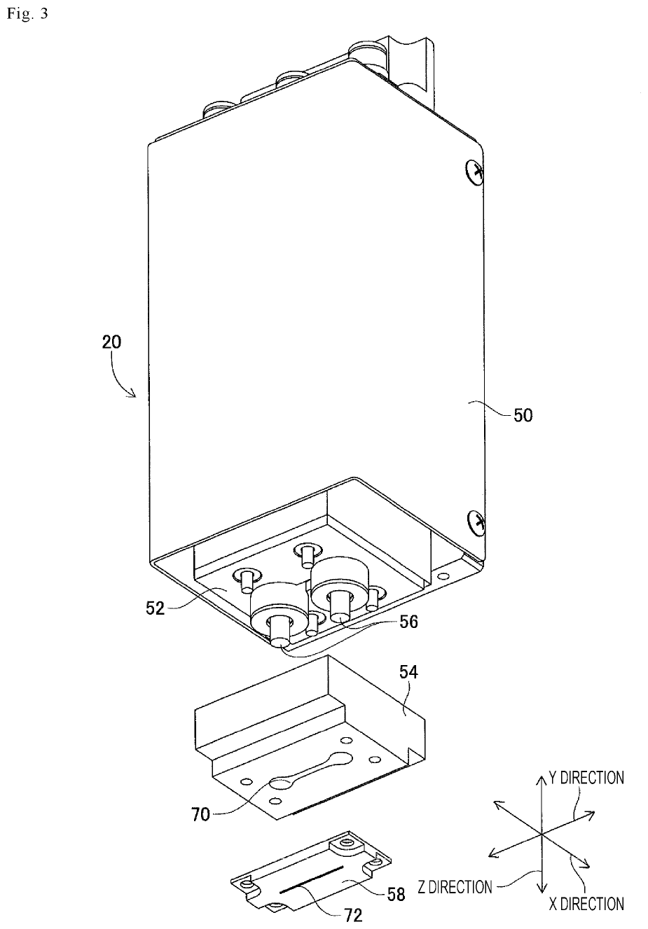

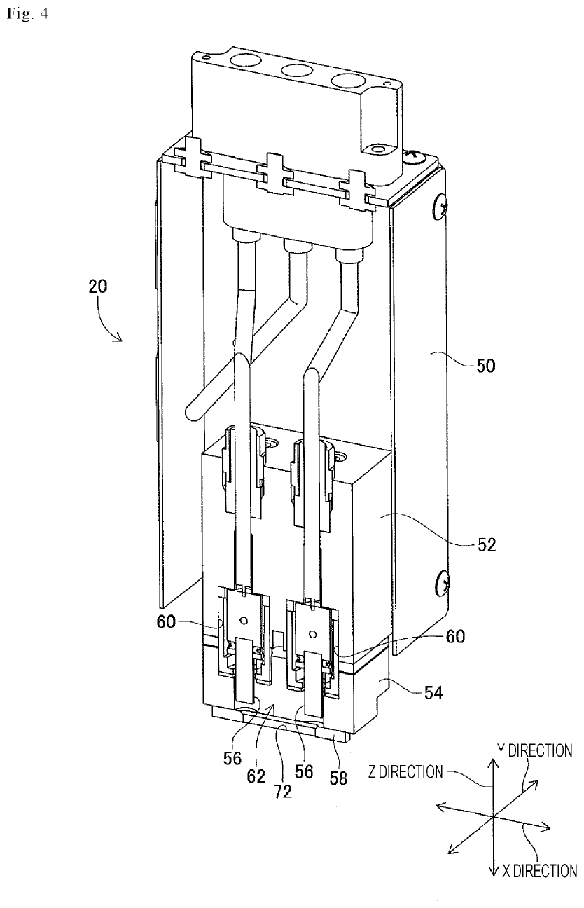

As shown in FIGS. 2 to 4, plasma generating device 20 includes cover 50, upper block 52, lower block 54, a pair of electrodes 56, and nozzle block 58. Cover 50 has a substantially covered square cylindrical shape, and upper block 52 is disposed inside cover 50. Upper block 52 has a substantially rectangular parallelepiped shape and is formed of ceramic. A pair of cylindrical recessed sections 60 having a cylindrical shape is formed on a lower surface of upper block 52.

Lower block 54 also has a substantially rectangular parallelepiped shape and is formed of ceramic. Recessed section 62 is formed on an upper surface of lower block 54, and is configured to be provided with a pair of cylindrical recessed sections 66 having a cylindrical shape and connecting recessed section 68 which connects the pair of cylindrical recessed sections 66 to each other. In addition, lower block 54 is fixed to the lower surface of upper block 52 in a state of protruding from a lower end of cover 50, and cylindrical recessed section 60 of upper block 52 and cylindrical recessed section 66 of lower block 54 communicate with each other. Cylindrical recessed section 60 and cylindrical recessed section 66 have substantially the same diameter. In addition, slit 70 passing through a lower surface of lower block 54 is formed on a bottom surface of recessed section 62.

Each of the pair of electrodes 56 is disposed in a cylindrical space defined by cylindrical recessed section 60 of upper block 52 and cylindrical recessed section 66 of lower block 54. The outer diameter of electrode 56 is smaller than the inner diameters of cylindrical recessed sections 60 and 66. Nozzle block 58 has a substantially flat plate shape and is fixed to the lower surface of lower block 54. Ejection port 72 communicating with slit 70 of lower block 54 is formed on nozzle block 58 and ejection port 72 passes through nozzle block 58 in the up-down direction.

Plasma generating device 20 further includes processing gas supply device 74 (see FIG. 10). Processing gas supply device 74 is a device that supplies a processing gas in which an active gas such as oxygen and an inert gas such as nitrogen are mixed at an arbitrary ratio, and is connected to cylindrical spaces defined by cylindrical recessed sections 60 and 66, and an upper portion of connecting recessed section 68 via a pipe (not shown). Thus, the processing gas is supplied into the inside of recessed section 62 from the gap between electrode 56 and cylindrical recessed section 66 and the upper portion of connecting recessed section 68.

With this structure, plasma generating device 20 ejects plasma from ejection port 72 of nozzle block 58. Specifically, the processing gas is supplied into the inside of recessed section 62 by processing gas supply device 74. At this time, in recessed section 62, a voltage is applied to the pair of electrodes 56, and a current flows between the pair of electrodes 56. Thus, a discharge occurs between the pair of electrodes 56, and the processing gas is converted into plasma by the discharge. Then, the plasma is ejected from ejection port 72 via slit 70.

As shown in FIG. 5, cover housing 22 includes upper cover 76 and lower cover 78. Upper cover 76 has a substantially covered cylindrical shape, and a through hole (not shown) having a shape corresponding to lower block 54 of plasma generating device 20 is formed in the lid portion of upper cover 76. Cover 50 of plasma generating device 20 is fixed in a state of standing upright on the lid portion of upper cover 76 to cover the through hole. For this reason, lower block 54 and nozzle block 58 of plasma generating device 20 protrude toward the inside of upper cover 76 to extend in the Z direction. As a result, the plasma generated by plasma generating device 20 is ejected in the Z direction from ejection port 72 of nozzle block 58 toward the inside of upper cover 76.

On the side surface of upper cover 76, a substantially rectangular through hole (not shown) is formed at 3 equidistant positions, and transparent glass plate 80 is disposed to close the through hole. This enables the inside of upper cover 76 to be visually recognized through glass plate 80.

Lower cover 78 of cover housing 22 has a substantially disk-shape, and is fixed to a housing (not shown) of a placement section on which atmospheric pressure plasma irradiation apparatus 10 is placed. An outer diameter of lower cover 78 is larger than an outer diameter of upper cover 76, and annular packing 82 having the same diameter as that of upper cover 76 is disposed on an upper surface of lower cover 78. When upper cover 76 is slid downward by opening and closing mechanism 24, upper cover 76 comes into close contact with packing 82, and the inside of cover housing 22 is sealed.

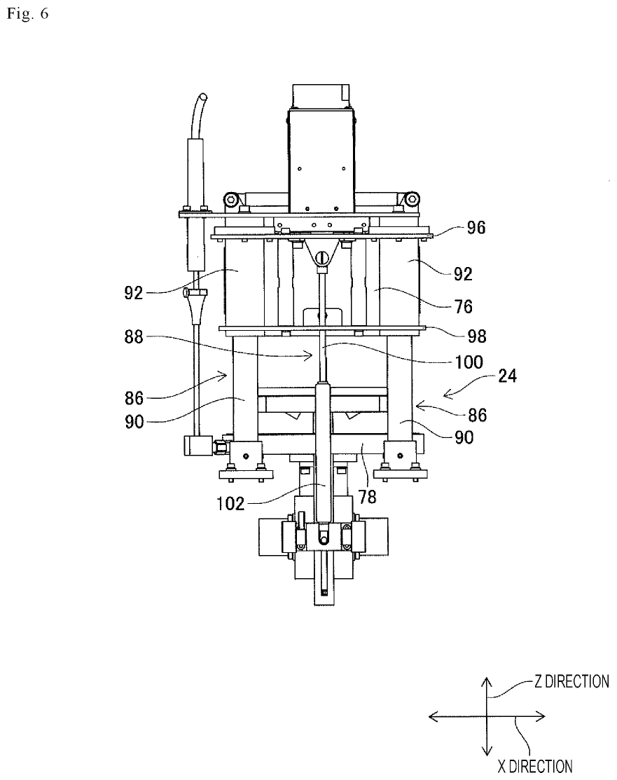

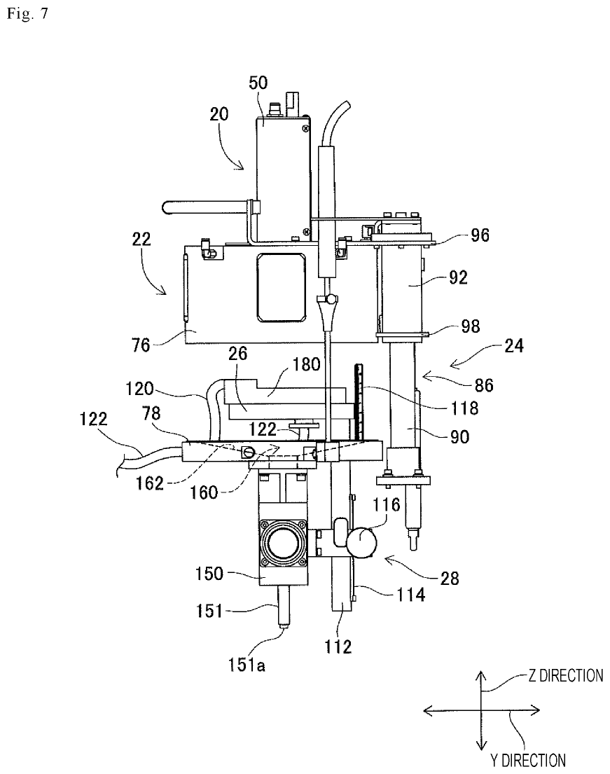

Specifically, as shown in FIGS. 6 and 7, opening and closing mechanism 24 includes a pair of slide mechanisms 86 and air cylinder 88. Each slide mechanism 86 includes support shaft 90 and slider 92. Support shaft 90 stands upright on the housing of the placement section to extend in the Z direction. Slider 92 has a substantially cylindrical shape and is externally fitted to support shaft 90 to be slidable in an axial direction of support shaft 90. Upper cover 76 is held by slider 92 by upper bracket 96 and lower bracket 98. Thus, upper cover 76 is slidable in the Z direction, that is, in the up-down direction.

Air cylinder 88 includes rod 100, a piston (not shown), and cylinder 102. Rod 100 is disposed to extend in the Z direction, and is fixed to upper cover 76 at an upper end portion thereof. A piston is fixed to a lower end portion of rod 100. The piston is fitted inside from the upper end of cylinder 102 and slidably moves inside cylinder 102. A lower end portion of cylinder 102 is fixed to the housing of the placement section, and a predetermined amount of air is sealed inside cylinder 102.

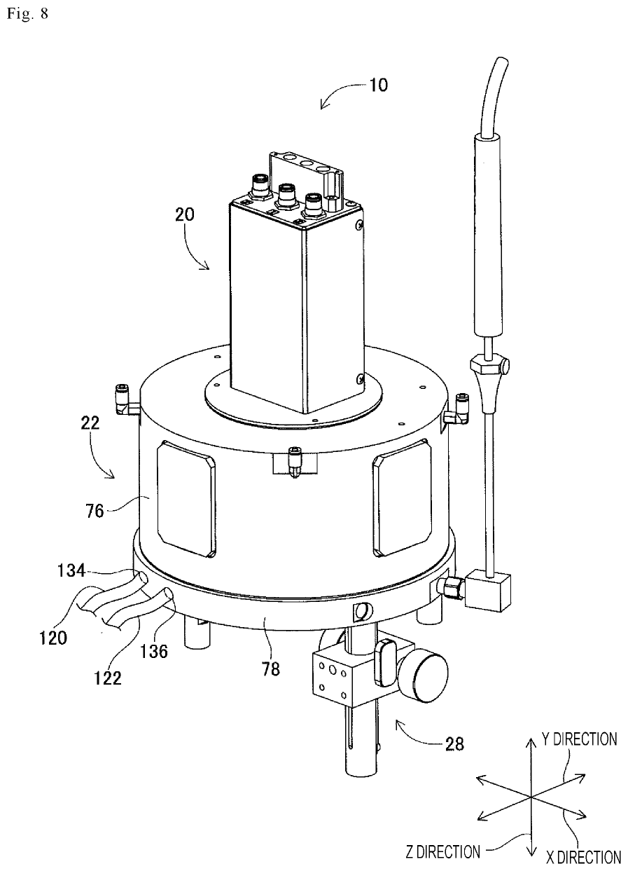

As a result, air cylinder 88 functions as a damper, and rapid descent of upper cover 76 is prevented. The air pressure inside cylinder 102 is designated as compressible pressure due to the weight of an integrated object that slides together with upper cover 76, that is, the weight of upper cover 76, plasma generating device 20, slider 92, and the like. That is, when a worker releases upper cover 76 in a state where upper cover 76 is lifted, upper cover 76 is lowered by the own weight of upper cover 76 and the like. Upper cover 76 comes into close contact with packing 82 of lower cover 78, and as shown in FIG. 8, the inside of cover housing 22 is sealed by upper cover 76 and lower cover 78.

Further, the worker lifts upper cover 76 to open the inside of cover housing 22. Magnet 106 (see FIG. 1) is fixed on the upper surface of upper cover 76, and when upper cover 76 is lifted, magnet 106 attaches to the housing of the placement section. In this way, by attaching magnet 106 to the housing of the placement section, the state in which upper cover 76 is lifted, that is, the state in which cover housing 22 is opened, is maintained.

Stage 26 has a substantially disk-shape, and irradiation block 180 is placed on the upper surface of stage 26. An outer diameter of stage 26 is smaller than the outer diameter of lower cover 78. Stage 26 is disposed on the upper surface of lower cover 78.

Irradiation block 180 is used to generate a plasma processed liquid by storing the liquid to be processed that has been delivered to liquid delivery tube 120 and irradiating the stored liquid to be processed with plasma ejected from plasma generating device 20. The generated plasma processed liquid is discharged from irradiation block 180 by liquid discharge tube 122.

The liquid to be processed is sent out to liquid delivery tube 120 by using supply pump 190 (see FIG. 10) provided outside cover housing 22, and is supplied to irradiation block 180 in cover housing 22. Further, the plasma processed liquid generated in irradiation block 180 is discharged from irradiation block 180 to liquid discharge tube 122 using discharge pump 192 (see FIG. 10), and is stored in a temporary storage bin (not shown) provided outside cover housing 22. Accordingly, through holes 134 and 136 are formed in a side surface of lower cover 78, through which liquid delivery tube 120 and liquid discharge tube 122 pass, respectively.

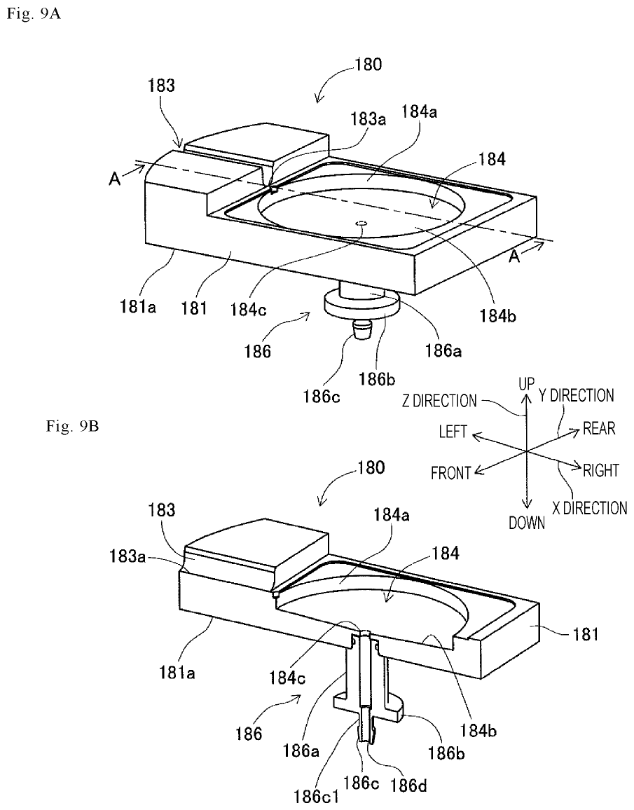

FIG. 9 shows a schematic configuration of irradiation block 180. FIG. 9A is a perspective view showing an appearance of entire irradiation block 180, and FIG. 9B is a cross-sectional perspective view of the A-A line of FIG. 9A. The direction from left to right is the direction in which the liquid to be processed flows.

Irradiation block 180 is formed of a ceramic and includes irradiation block body section 181 having a substantially rectangular parallelepiped shape. The long side direction of irradiation block 180 is the X direction, and the short side direction is the Y direction. When installed in cover housing 22, irradiation block body section 181 has groove section 183 and storage section 184 whose faces facing plasma generating device 20 are opened.

Groove section 183 has a U shape whose YZ cross-section opens upward. Bottom surface 183a constituting groove section 183 is curved. The YZ cross-section of groove section 183 is slightly narrower than the cross-sectional shape of liquid delivery tube 120 (see FIG. 1), and liquid delivery tube 120 is fixed by fitting flexible liquid delivery tube 120 into groove section 183.

Storage section 184 stores the liquid to be processed for plasma irradiation. Storage section 184 is formed of a cylindrical recessed section including side surface 184a and bottom surface 184b. Bottom surface 184b constituting storage section 184 is formed to be positioned below bottom surface 183a constituting groove section 183. Further, liquid discharge hole 184c for discharging the plasma processed liquid generated by plasma irradiation of the liquid to be processed from storage section 184 is formed on bottom surface 184b constituting storage section 184. Bottom surface 184b is an inclined surface inclined downward from side surface 184a toward liquid discharge hole 184c. This is to achieve the function of quickly discharging the plasma processed liquid from storage section 184 and the function of preventing a state in which a part of the plasma processed liquid remains in storage section 184 without being discharged as much as possible, when discharging the plasma processed liquid.

Irradiation block body section 181 includes discharge section 186 in addition to the above configuration. Discharge section 186 is formed to protrude downward from a position that is lower surface 181a of irradiation block body section 181 and includes liquid discharge hole 184c of storage section 184. Discharge section 186 has base portion 186a, flange portion 186b, and discharge locking portion 186c, and each of elements 186a to 186c is integrally formed in a connected state downwardly. Further, through hole 186d is formed in the Z direction at the center of discharge section 186, and communicates with liquid discharge hole 184c of storage section 184.

On the outer peripheral surface of discharge section 186, the portion continuous with lower surface 181a of irradiation block body section 181 is base portion 186a. The diameter of the outer periphery of discharge locking portion 186c formed with flange portion 186b interposed below base portion 186a is larger than the diameter of liquid discharge tube 122 (see FIG. 1). The outer diameter of upper portion 186c1 of discharge locking portion 186c is smaller than the outer diameter of discharge locking portion 186c. Thus, when flexible liquid discharge tube 122 is fitted to upper portion 186c1, liquid discharge tube 122 is deformed along the outer periphery of discharge locking portion 186c, and discharge tube 122 is fixed. Further, irradiation block 180 is fixed to stage 26 by fitting base portion 186a and cutout portion 26a of stage 26 (see FIG. 1). In this way, since it is not fixed using fasteners, irradiation block 180 can be easily attached to and detached from stage 26.

As shown in FIG. 7, lifting and lowering device 28 includes support rod 112, rack 114, pinion 116, and electromagnetic motor 117 (see FIG. 10). A through hole (not shown) penetrating in the up-down direction is formed in lower cover 78, and support rod 112 is inserted into the through hole. The outer diameter of support rod 112 is smaller than the inner diameter of the through hole, and support rod 112 is movable in the up-down direction, that is, in the Z direction. The lower surface of stage 26 is fixed to the upper end of support rod 112.

Rack 114 is fixed to an outer peripheral surface of a portion extending downward from lower cover 78 of support rod 112 so as to extend in the axial direction of support rod 112. Pinion 116 is meshed with rack 114 and is rotated by the drive of electromagnetic motor 117. Pinion 116 is rotatably held by the housing of the placement section. With this structure, when pinion 116 is rotated by the drive of electromagnetic motor 117, support rod 112 moves in the Z direction, and stage 26 is lifted and lowered. Measurement rod 118 stands upright, adjacent to stage 26, on the upper surface of lower cover 78. Graduations are marked on the outer peripheral surface of measurement rod 118, and the height of stage 26 in the Z direction, that is, the lifting and lowering amount of stage 26 can be visually checked by the graduations.

As shown in FIG. 5, purge gas supply mechanism 32 includes four air joints 130 (three are shown in the drawing) and purge gas supply device 132 (see FIG. 10). Four air joints 130 are provided at four equidistant positions at the upper end portion of the side surface of upper cover 76, and each air joint 130 opens into the inside of upper cover 76. Purge gas supply device 132 is a device that supplies an inert gas such as nitrogen, and is connected to each air joint 130 via a pipe (not shown). With this structure, purge gas supply mechanism 32 supplies the inert gas into the inside of upper cover 76.

Concentration detection mechanism 34 includes air joint 140, pipe 142, and detection sensor 144 (see FIG. 10). Lower cover 78 is formed with a through hole (not shown) communicating with the upper surface and side surface of lower cover 78. Opening 146 of the through hole on the upper surface side of lower cover 78 is positioned inside packing 82. Meanwhile, air joint 140 is connected to the opening of the through hole on the side surface side of lower cover 78. Detection sensor 144 is a sensor that detects oxygen concentration and is connected to air joint 140 via pipe 142. With this structure, concentration detection mechanism 34 detects the oxygen concentration inside cover housing 22 when cover housing 22 is sealed.

As shown in FIG. 1, exhaust mechanism 36 includes L-shaped pipe 150, connecting pipe 152, and main pipe 154. As shown in FIG. 7, lower cover 78 is formed with duct port 160 opening into the upper surface and the lower surface. The opening of duct port 160 on the upper surface side of lower cover 78 is configured with tapered surface 162 where inner diameter increases as it extends upward. That is, when cover housing 22 is sealed, tapered surface 162 is inclined toward the inner wall surface of upper cover 76. Meanwhile, L-shaped pipe 150 is connected to the opening of duct port 160 on the lower surface side of lower cover 78. Main pipe 154 is connected to L-shaped pipe 150 via connecting pipe 152. A portion of connecting pipe 152 on L-shaped pipe 150 side is omitted. Ozone filter 166 is disposed inside main pipe 154. Ozone filter 166 is formed with activated charcoal, which adsorbs ozone.

Control device 38 includes controller 170 and multiple drive circuits 172 as shown in FIG. 10. Multiple drive circuits 172 are connected to electrode 56, processing gas supply device 74, electromagnetic motor 117, purge gas supply device 132, supply pump 190, and discharge pump 192. Controller 170 includes CPU, ROM, RAM, and the like, is mainly a computer, and is connected to multiple drive circuits 172. Thus, operations of plasma generating device 20, lifting and lowering device 28, purge gas supply mechanism 32, supply pump 190, and discharge pump 192 are controlled by controller 170. Furthermore, controller 170 is connected to detection sensor 144. As a result, controller 170 acquires a detection result detected by detection sensor 144, that is, oxygen concentration inside cover housing 22.

Since the culture solution is activated by irradiating the culture solution with plasma, utilization of plasma in the medical field such as cancer treatment using the culture solution irradiated with plasma is expected. Therefore, processes such as the generation of culture solution irradiated with plasma are performed, but it is preferable that the culture solution is irradiated with plasma in a state where the conditions for the plasma irradiation are managed. In atmospheric pressure plasma irradiation apparatus 10, with the above-described configuration, by placing irradiation block 180 on stage 26 and sealing cover housing 22, it is possible to irradiate the culture solution with plasma under predetermined conditions. Hereinafter, a method of irradiating the culture solution with plasma under predetermined conditions will be described in detail.

Specifically, first, irradiation block 180 is placed on stage 26. Next, lifting and lowering device 28 lifts and lowers stage 26 to an arbitrary height. Accordingly, it is possible to arbitrarily set the distance between plasma ejection port 72 and the culture solution as plasma irradiation target. The lifting and lowering height of stage 26 can be confirmed by the graduations of measurement rod 118.

Next, upper cover 76 is lowered to seal cover housing 22. Then, an inert gas is supplied to the inside of cover housing 22 by purge gas supply mechanism 32. At this time, oxygen concentration in cover housing 22 is detected by concentration detection mechanism 34. Then, after the detected oxygen concentration becomes equal to or lower than a threshold set in advance, plasma is ejected into the inside of cover housing 22 by plasma generating device 20. At this time, plasma is irradiated toward irradiation block 180 disposed below nozzle block 58 of plasma generating device 20. Even when the plasma is irradiated, the supply of the inert gas into the inside of cover housing 22 is continuously performed.

Then, after the plasma is irradiated toward irradiation block 180 for a predetermined time by plasma generating device 20, the liquid to be processed, which has been adjusted to a constant flow rate, is supplied by the operation of supply pump 190 to storage section 184 of irradiation block 180 via liquid delivery tube 120. That is, plasma generating device 20 performs a warm-up operation by irradiating storage section 184 of irradiation block 180 in a state where there is no liquid to be processed, that is, empty storage section 184 with plasma for a predetermined time. Then, after the plasma is irradiated toward irradiation block 180 for a predetermined time, the liquid to be processed is supplied to storage section 184 of irradiation block 180 by the operation of supply pump 190. Then, after a predetermined amount of the liquid to be processed is supplied to storage section 184 by supply pump 190, the operation of supply pump 190 stops. Thus, a predetermined amount of the liquid to be processed is stored in storage section 184 of irradiation block 180, and the liquid to be processed stored in storage section 184 is activated by the plasma gas irradiation from plasma generating device 20. It has been found that by irradiating the liquid to be processed with plasma gas for a predetermined time, the therapeutic effect by the liquid to be processed irradiated with plasma is exerted. Therefore, the liquid to be processed stored in storage section 184 is irradiated with the plasma gas for a predetermined time. Further, the liquid to be processed is naturally convected in storage section 184 by being irradiated with the plasma gas. Accordingly, it is possible to obtain a uniform activated plasma processed liquid in which the therapeutic effect is exerted.

As described above, by supplying the inert gas into the inside of cover housing 22, the air in cover housing 22 is exhausted to the outside of cover housing 22. At this time, by adjusting the oxygen concentration in cover housing 22, conditions that affect plasma irradiation are managed. Specifically, since plasma contains active radicals, in a case where plasma reacts with oxygen, ozone is produced, and as a result, an effect of plasma irradiation is lowered. Therefore, by adjusting the oxygen concentration in cover housing 22, the influence of the oxygen concentration on the effect of the culture solution irradiated with plasma can be investigated. In addition, the culture solution can be irradiated with plasma under the same conditions. Accordingly, it is possible to efficiently generate the plasma processed liquid.

In atmospheric pressure plasma irradiation apparatus 10, as described above, the distance between plasma ejection port 72 and the culture solution is arbitrarily set. Accordingly, it is possible to investigate the influence of the irradiation distance on the effect of the culture solution irradiated with plasma, and to efficiently generate the plasma processed liquid.

Duct port 160 is formed in lower cover 78. Therefore, by supplying inert gas into cover housing 22, the inside of cover housing 22 becomes a positive pressure and is naturally exhausted from the inside of cover housing 22. Tapered surface 162 having an inner diameter larger toward the upper surface of lower cover 78 is formed in duct port 160 of lower cover 78. Accordingly, it is possible to promote the exhaustion of the gas from the inside of cover housing 22. Further, exhaust mechanism 36 is provided with ozone filter 166. Accordingly, even when plasma and oxygen react and ozone is generated, it is possible to prevent the ozone from being exhausted to the outside.

When a predetermined time elapses after the plasma irradiation of the liquid to be processed is started, the plasma processed liquid stored in storage section 184 is discharged by the operation of discharge pump 192 via liquid discharge tube 122. When a predetermined time elapses after the discharge of the plasma processed liquid from storage section 184 is started, it is considered that the plasma processed liquid does not remain in storage section 184, and the discharge of the plasma processed liquid from storage section 184 is completed. Then, the liquid to be processed for the next plasma processing is supplied to storage section 184 of irradiation block 180 by the operation of supply pump 190 via liquid delivery tube 120. Hereinafter, the plasma processing, including the plasma irradiation for a predetermined time of the liquid to be processed stored in storage section 184, the discharge of the plasma processed liquid, the supply of the new liquid to be processed to irradiation block 180, the plasma irradiation of the liquid to be processed, and so forth, is repeatedly performed until a target amount of the plasma processed liquid is generated.

In this manner, a series of processes of supplying the liquid to be processed to irradiation block 180, irradiating the liquid to be processed stored in storage section 184 with plasma, and discharging the plasma processed liquid are repeated to generate the target amount of the plasma processed liquid. However, since the capacity of storage section 184 of irradiation block 180 is relatively small, it is necessary to repeat the series of processes described above the significant number of times in order to generate the target amount of the plasma processed liquid. Specifically, for example, when the capacity of storage section 184 is about 10 ml and the target amount of the plasma processed liquid is 2 L, the series of processes described above needs to be repeated 200 times. Therefore, in the method of generating the plasma processed liquid by repeating a series of processes of supplying the liquid to be processed, irradiating the liquid to be processed stored in storage section 184 with plasma, and discharging the plasma processed liquid, it is difficult to generate a large amount of the plasma processed liquid. Then, the plasma processing, including while the liquid to be processed is supplied to storage section 184, discharging the liquid to be processed from storage section 184, and irradiating the liquid to be processed supplied to storage section 184 with plasma, is performed.

Specifically, first, when the liquid to be processed is discharged from storage section 184 while the liquid to be processed is supplied to storage section 184, the supply amount per unit time of supply pump 190 and the discharge amount per unit time of discharge pump 192 are adjusted so that the liquid to be processed is stored in storage section 184. The process of adjusting the supply amount per unit time of supply pump 190 and the discharge amount per unit time of discharge pump 192 (hereinafter referred to as “adjustment processing”) is executed before the plasma processed liquid is generated in atmospheric pressure plasma irradiation apparatus 10.

In the adjustment processing, a weight sensor for measuring the weight of irradiation block 180 is disposed, and the adjustment processing is executed based on the measurement value of the weight sensor. First, when the supply amount per unit time of supply pump 190 and the discharge amount per unit time of discharge pump 192 are equal, it is considered that the storage amount of the liquid to be processed in storage section 184 does not change. That is, when only the supply pump is operated to store a predetermined amount of the liquid to be processed in the storage section, and then the supply pump and the discharge pump are operated simultaneously to make the supply amount per unit time of the supply pump equal to the discharge amount per unit time of the discharge pump, it is considered that the storage amount of the liquid to be processed is maintained at a predetermined amount. However, when the liquid to be processed is supplied to storage section 184, the liquid to be processed is supplied against the weight of the liquid to be processed, and when the liquid to be processed is discharged from storage section 184, the liquid to be processed is discharged using its own weight. Therefore, in order to make the actual supply amount per unit time of supply pump 190 equal to the actual discharge amount per unit time of discharge pump 192, it is necessary to make the command value for supply pump 190 larger than the command value for discharge pump 192. Specifically, for example, when it is desired to set the actual supply amount per unit time and the actual discharge amount per unit time to 2 ml/min, the command value to supply pump 190 needs to be 2.1 ml/min, and the command value to discharge pump 192 needs to be 1.9 ml/min. When the liquid to be processed stored in storage section 184 is irradiated with plasma, the liquid to be processed evaporates slightly. Therefore, even if the actual supply amount per unit time and the actual discharge amount per unit time are equal, the storage amount of the liquid to be processed decreases with the plasma irradiation of the liquid to be processed. In consideration of this, in order to make the actual supply amount per unit time larger than the actual discharge amount per unit time, it is necessary to set the command value to supply pump 190 to 2.11 ml/min.

In this way, the command values for supply pump 190 and discharge pump 192 are determined, these command values are input to supply pump 190 and discharge pump 192, and while actually supplying the liquid to be processed to storage section 184 by the supply pump, the liquid to be processed is discharged from storage section 184 by the discharge pump. At this time, the weight of irradiation block 180 is measured by the weight sensor disposed in irradiation block 180. When the measurement value of the weight sensor does not change, the input command value is determined as a target command value (hereinafter referred to as a “target command value”). When the measurement value of the weight sensor decreases, correction is performed to increase the command value to supply pump 190 or to decrease the command value to discharge pump 192. On the other hand, when the measurement value of the weight sensor increases, correction is performed to decrease the command value to supply pump 190 or to increase the command value to discharge pump 192. Then, the command value is corrected until the measurement value of the weight sensor does not change, and the command value at the point when the measurement value of the weight sensor does not change is determined as the target command value. When the target command values of supply pump 190 and discharge pump 192 are determined in this way, the adjustment processing of the supply amount per unit time of supply pump 190 and the discharge amount per unit time of discharge pump 192 is completed.

When the adjustment processing is completed, a plasma processed liquid generation process is performed. In the plasma processed liquid generation process, the weight sensor is detached from irradiation block 180. First, in the plasma processed liquid generation process, as described above, plasma generating device 20 irradiates empty irradiation block 180 with plasma for a predetermined time as the warm-up operation. When the warm-up operation for the predetermined time is completed, the target command value is input to supply pump 190 to operate, and the liquid to be processed is supplied to storage section 184 of irradiation block 180. At this time, plasma generating device 20 continuously irradiates irradiation block 180 with plasma. Then, when a predetermined amount of the liquid to be processed is stored in storage section 184, the target command value is input to discharge pump 192 to operate, and the liquid to be processed is discharged from storage section 184. At this time, the storage amount of the liquid to be processed in storage section 184 is maintained at a constant amount without changing. Then, the liquid to be processed, which is stored in storage section 184 at a constant amount, is irradiated with plasma. For example, when the storage amount of the liquid to be processed in storage section 184 is 10 ml, and the actual supply amount per unit time of supply pump 190 and the actual discharge amount per unit time of discharge pump 192 are about 2 ml/min, the liquid to be processed is retained in storage section 184 for about 5 minutes. Therefore, the liquid to be processed irradiated with plasma for about 5 minutes is generated as a plasma processed liquid. Plasma generating device 20, supply pump 190, and discharge pump 192 are continuously operated until the target amount of the plasma processed liquid is generated. That is, in the conventional method, generation of a small amount of the plasma processed liquid is repeatedly and intermittently performed, whereas in the method of the present disclosure, the plasma processed liquid is continuously generated. Accordingly, it is possible to generate a large amount of the plasma processed liquid.

As shown in FIG. 10, controller 170 of control device 38 includes adjustment section 200, pre-irradiation section 202, supply section 204, discharge section 206, and irradiation section 208. Adjustment section 200 is a function section for executing the above-described adjustment processing. Pre-irradiation section 202 is a functional section that irradiates empty irradiation block 180 with plasma. Supply section 204 is a functional section that supplies the liquid to be processed to storage section 184 of irradiation block 180. Discharge section 206 is a functional section that discharges the liquid to be processed from storage section 184 while supplying the liquid to be processed to storage section 184 of irradiation block 180. Irradiation section 208 is a functional section that irradiates the liquid to be processed supplied to storage section 184 of irradiation block 180 with plasma.

In the example described above, atmospheric pressure plasma irradiation apparatus 10 is an example of a plasma irradiation apparatus. Plasma generating device 20 is an example of a plasma generating device. Cover housing 22 is an example of a housing. Irradiation block 180 is an example of a container. Supply pump 190 is an example of a supply device. Discharge pump 192 is an example of a discharge device. A step executed by adjustment section 200 is an example of an adjustment step. A step executed by pre-irradiation section 202 is an example of a pre-irradiation step. A step executed by supply section 204 is an example of a supply step. A step executed by discharge section 206 is an example of a discharge step. A step executed by irradiation section 208 is an example of an irradiation step.

The present embodiment, which has been described heretofore, provides the following effects.

In atmospheric pressure plasma irradiation apparatus 10, while the liquid to be processed is supplied to storage section 184, the liquid to be processed is discharged from storage section 184, and the liquid to be processed supplied to storage section 184 is irradiated with plasma. Accordingly, it is possible to continuously generate the plasma processed liquid, and it is possible to generate a large amount of the plasma processed liquid.

While the liquid to be processed is supplied to storage section 184, the liquid to be processed is discharged from storage section 184, and the liquid to be processed stored in storage section 184 is irradiated with plasma. Accordingly, it is possible to irradiate the liquid to be processed with plasma for a predetermined time, and it is possible to generate a uniform activated plasma processed liquid in which the therapeutic effect is exerted.

Further, the supply amount per unit time of supply pump 190 and the discharge amount per unit time of discharge pump 192 are adjusted so that the liquid to be processed supplied to storage section 184 is stored. Thus, it is possible to properly store the liquid to be processed in storage section 184 for a predetermined time.

When the liquid to be processed stored in storage section 184 is irradiated with plasma, the liquid to be processed evaporates slightly. The supply amount per unit time to storage section 184 is larger than the discharge amount per unit time from storage section 184. Accordingly, it is possible to properly store the liquid to be processed in storage section 184 in consideration of evaporation of the liquid to be processed.

Further, irradiation block 180, in which the liquid to be processed is stored, is disposed inside sealed cover housing 22, and the liquid to be processed is supplied to irradiation block 180 placed inside the sealed cover housing. The liquid to be processed is discharged from irradiation block 180 placed inside the sealed cover housing. Accordingly, it is possible to properly perform plasma irradiation to the liquid to be processed stored in irradiation block 180.

Further, irradiation block 180 before the liquid to be processed is supplied, that is, empty irradiation block 180 is irradiated with plasma. Accordingly, it is possible to more properly irradiate the liquid to be processed with plasma by plasma generating device 20 after the warm-up operation.

The present disclosure is not limited to the example described above, and can be carried out in various aspects to which various modifications and improvements are applied based on the knowledge of those skilled in the art. For example, in the above example, the liquid to be processed is irradiated with plasma inside sealed cover housing 22, but the liquid to be processed may be irradiated with plasma in an open space. In the above example, the liquid to be processed is irradiated with plasma under atmospheric pressure, but the liquid to be processed may be irradiated with plasma under reduced pressure.

In the above example, the culture solution is adopted as the liquid to be processed, but it is possible to adopt a liquid other than the culture solution as the liquid to be processed. In addition, the present disclosure is not limited to the medical field, and the present disclosure can be applied to various fields such as an industrial field.

### REFERENCE SIGNS LIST

10: atmospheric pressure plasma irradiation apparatus (plasma irradiation apparatus), 20: plasma generating device, 22: cover housing (housing), 180: irradiation block (container), 190: supply pump (supply device), 192: discharge pump (discharge device), 200: adjustment section (adjustment step), 202: pre-irradiation section (pre-irradiation step), 204: supply section (supply step), 206: discharge section (discharge step), 208: irradiation section (irradiation step)

1. A method for producing a plasma processed liquid, comprising:
a supply step of supplying a liquid to be processed to a container;
a discharge step of discharging the liquid to be processed from the container while supplying the liquid to be processed to the container in the supply step; and
an irradiation step of irradiating the liquid to be processed supplied to the container with plasma,
wherein the plasma processed liquid is produced by irradiation of plasma in the irradiation step.

2. The method for producing a plasma processed liquid according to claim 1,
wherein the method includes the irradiation step of irradiating the liquid to be processed stored in the container with plasma by the supply of the liquid to be processed to the container.

3. The method for producing a plasma processed liquid according to claim 2, further comprising:
an adjustment step of adjusting a supply amount per unit time of the liquid to be processed in the supply step and a discharge amount per unit time of the liquid to be processed in the discharge step so that the liquid to be processed supplied to the container is stored.

4. The method for producing a plasma processed liquid according to claim 1,
wherein the method includes the supply step of supplying a larger amount of the liquid to be processed than a discharge amount of the liquid to be processed discharged from the container in the discharge step.

5. The method for producing a plasma processed liquid according to claim 1,
wherein the method includes the supply step of supplying the liquid to be processed to the container placed inside a sealed housing, and
the discharge step of discharging the liquid to be processed from the container placed inside the sealed housing.

6. The method for producing a plasma processed liquid according to claim 1, further comprising:
a pre-irradiation step of irradiating the container with plasma before the liquid to be processed is supplied in the supply step.

7. A plasma irradiation apparatus, comprising:
a supply device configured to supply a liquid to be processed to a container;
a discharge device configured to discharge the liquid to be processed from the container while supplying the liquid to be processed to the container by the supply device; and
a plasma generating device configured to generate plasma to irradiate the liquid to be processed supplied to the container.
